(19) United States
(12) Patent Application Publication
(10) Pub. No.: US 2010/0215076 A1
(43) Pub. Date: Aug. 26, 2010

(54) Redundant Signal Transmission

(76) Inventors: Herbert Froitzheim, Pettendorf (DE); Martin Opitz, Regensburg (DE)

Correspondence Address: King & Spalding LLP, 401 Congress Avenue, Suite 3200, Austin, TX, 78701, US

(21) Appl. No.: 12/593,420

(22) PCT Filed: Feb. 27, 2008
(86) PCT No.: PCT/EP08/52343

§ 371 Date: Mar. 5, 2010

(30) Foreign Application Priority Data
Mar. 28, 2007 (DE) 10 2007 014 997.4

(51) Int. Cl. H04L 27/00; H04B 1/69

(52) U.S. Cl. 375/130; 375/295; 375/E01.001

(57) ABSTRACT

In a method and a device (10) for transmitting a digital signal sequence, with a prescribed number of individual signals, over large distances relative to the transmission power, the digital signal sequence is repeatedly sent from a first communication device (1, 1a). A second communication device (2, 2a) receives the repeatedly sent signal sequence, wherein a first series of consecutive individual signals of the repeatedly sent digital signal sequence is received (S1) first, the number of individual signals corresponding to the number of consecutive individual signals prescribed for the digital signal sequence. The sequence of individual signals is converted into a sequence of symbol values representing the individual signals and stored in a register (24). Further sequences of individual signals received at a defined time interval after the first sequence of individual signals are also converted into symbol value sequences and superimposed on the sequence stored in the register (24).

### CROSS-REFERENCE TO RELATED APPLICATIONS

This application is a U.S. National Stage Application of International Application No. PCT/EP2008/052343 filed Feb. 27, 2008, which designates the United States of America, and claims priority to German Application No. 10 2007 014 997.4 filed Mar. 28, 2007, the contents of which are hereby incorporated by reference in their entirety.

### TECHNICAL FIELD

The invention relates to the transmission of signals, the energy content of which at the receiver is close to the background noise, or disappears in the background noise. The invention relates in particular to a bidirectional signal transmission between a transmit and receive device which is partially mobile, and a further base station for a radio-based access arrangement, which is generally arranged in a vehicle.

### BACKGROUND

For modern access authorization systems or access control systems, as applicable, increasing use is being made of electronic security systems or access arrangements, in which the authentication of a person with access authorization is effected with the aid of a data communication which takes place between a first communication device, generally arranged on the accessed object, and a second communication device, generally mobile, which is in the possession of the person with access authorization. The range of systems of this type is restricted to a few meters, because the verification of the access authorization is intended only to be effected in the immediate neighborhood of the vehicle, so as to offer unauthorized persons no opportunity for forcing an entry into the vehicle. Some suppliers offer systems with a range of up to about 100 meters.

However, for the purpose of controlling or regulating other vehicle systems, such as for example an engine or passenger compartment heater, remote operation over greater distances is desirable, so that when the person with access authorization arrives at the vehicle these systems are already functioning to the desired effect. Often there is the additional problem that the person with access authorization is not sure whether or not they have locked the vehicle. With the access systems currently available, they are obliged to go back into the neighborhood of the vehicle in order to check on the locking. Hence, for such situations it is again desirable to be able to query the particular statuses of vehicle systems over greater distances.

In order to make this possible, the communication range between the first and the second communication device must be extended up to as much as 500 m or more. Since the maximum transmission power of communication devices of this type is restricted in many countries by legal directives, at the required distances the power of the signal received at the other communication device concerned corresponds roughly to the level of the background noise. A transmission over such large distances thus calls for special measures for low-error receipt of the transmitted signal.

However, the susceptibility to error of a signal transmission is also determined by other interference factors. In the case of tire pressure monitoring systems in vehicles there is, for example, a transmission device on each wheel of the vehicle which is connected to the valve on the tire and which transmits particular operating data about the tire, such as for example the inflation pressure, temperature and other such items, by radio to a receiving device arranged in the region of the vehicle's bodywork. The tire-based transmission device is battery operated. For the longest possible intervals between battery changes, the transmission power must be kept low, without endangering the functional security of the transmission. In addition to the low transmission power however, the transmission is detrimentally affected by the rotation of the wheel and the influence of the tire. In the case of tire monitoring systems therefore, the transmission or message channels, as applicable, are subject to severe interference. This interference is attributable less to noise influences, but rather it manifests itself as more or less cyclical bit dropouts in the telegrams which are transmitted, caused by the rotation of the wheel. However, reducing the bit dropouts by higher transmission power is prohibited for the reasons given above.

To achieve low-error reception of signals, the energy content of which corresponds roughly to the noise level or which are distorted by other factors, as explained above, use has been made of so-called spread techniques, which increase the redundancy of a data transmission. One known method of this type is the DSSS method (Direct Sequence Spread Spectrum), by which the payload signal is multiplied by a spread code. Each bit of the payload signal is thereby replaced by a code which represents the bit concerned. The code consists in turn of a sequence of bits, which in this publication are referred to as symbols to identify them more clearly. By this encoding, each message bit, i.e. each bit in the payload signal, is expanded to correspond to the code length. Hence the codes used in representing the message bits are referred to as spread codes, and the number of symbols in a code, i.e. the code length, as the spread factor. What is ultimately transmitted is the series of symbol sequences which results from the encoding.

At the receiver end, the series of symbol sequences which has been transmitted is demodulated to extract the payload signal, using the spread code, which is also referred to as the chip sequence or chipping sequence. The multiplication of the received signal by the chipping sequence, used at the receiver for demodulation purposes, makes the DSSS signal insensitive to narrow-band interference, because the interference signal is spread by it and its power density is correspondingly reduced by the spread factor.

For the transmission of digital data, the spreading can be achieved using two symbol sequences, one of which represents the logical zero and the other the logical one. Conventionally, the two bit sequences are the inverse of each other, so that their autocorrelation only contains meaningless peaks.

The chipping sequence used for spreading expands each bit to be transmitted to a sequence of symbols which are correlated with each other. The correlation of the symbols, transmitted one after another or on different channels, makes the signal which is received distinguishable from the uncorrelated noise and other interference factors which are not correspondingly encoded, so that an increase in the reception sensitivity is achieved.

If the bit transmission rate is to be maintained in spite of the bit spreading, then the spread bits (the symbols) must be transmitted at a higher symbol rate, which results in spectrum spreading. However, at a higher transmission rate, the reception sensitivity falls off for hardware reasons. This loss is compensated by the code redundancy which is obtained by the bit spreading of the signal. One only obtains an improvement in the reception sensitivity for symbol transmission rates which correspond to lower bit rates than the bit rate for the transmission of the previously unspread bits. The increase in reception sensitivity is thus at the expense of the speed of communication of the payload data.

In order to be able to extract the transmitted data from the spread signal, the start of the individual spread codes must be determined at the receiver end, i.e. the receiver must synchronize itself with the spread codes. In the case of the spread factors of 200 to 500 which are conventionally used, this calls for an enormous computational effort with large registers, which is one of the important determinants of the current consumption by the receiving device.

### SUMMARY

According to various embodiments, a method and a device can be specified which, for a low computational and energy expenditure, nevertheless permits a secure transmission of data which is subject to significant interference factors and/or the energy content of which on receipt lies below the noise level.

According to an embodiment, a method for transmitting a digital signal sequence consisting of a prescribed number of individual signals, may comprise the steps:—repeated transmission of a digital signal sequence consisting of a prescribed number of consecutive individual signals, where the time interval between two consecutively-transmitted digital signal sequences is constant,—receiving a first series of consecutive individual signals from the repeatedly-transmitted digital signal sequence, where the number of individual signals in the first series which is received corresponds to the number of consecutive individual signals prescribed for the digital signal sequence,—determination of a first series of symbol values representative of the first series received, where each symbol value in this first series of symbol values represents exactly one individual signal from the first series which has been received,—storing the series of symbol values which represents the first series received in a first register storage device in such a way that each symbol value from the series of symbol values is stored in a separate storage area in the first register storage device,—receiving at least one further series of consecutive individual signals from the repeatedly-transmitted digital signal sequences at a defined time interval after the preceding series of consecutive individual signals which was received, where the number of individual signals in the further series which has been received corresponds in turn to the number of consecutive individual signals prescribed for the digital signal sequence,—determining a further series of symbol values, representing the further series which has been received, where each symbol value in the further series of symbol values represents exactly one individual signal in the further series which has been received,—carrying out a mathematical operation with the first series of symbol values and the further series of symbol values as the arguments, where this mathematical operation is applied in each case to symbol values which correspond to each other in the two series of symbol values and a symbol value from the first series of symbol values then corresponds to exactly one symbol value in the further series of symbol values if and only if both have the same position in their respective series of symbol values, and—storing the result of the mathematical operation in the first register storage device.

According to a further embodiment, the determination of a symbol value which represents an individual signal in a series which has been received may be effected by comparing a magnitude characteristic of the individual signal with a threshold value in such a way that the symbol value assumes a first value if the characteristic magnitude is greater than the threshold, and otherwise assumes a second value. According to a further embodiment, the determination of a symbol value which represents an individual signal in a series which has been received may be effected by comparing a magnitude characteristic of the individual signal with a threshold value in such a way that the symbol value assumes a second value if the characteristic magnitude is less than the threshold value, and otherwise assumes a first value. According to a further embodiment, the determination of a symbol value which represents an individual signal in a series which has been received may be effected by comparing a magnitude characteristic of the individual signal with at least two threshold values, in such a way that the symbol value assumes a value, which is assigned to the threshold value for the two or more threshold values, which has the smallest difference from the characteristic value of the individual signal. According to a further embodiment, the mathematical operation may include an addition. According to a further embodiment, the mathematical operation may include a weighted addition. According to a further embodiment, the mathematical operation may be performed in accordance with the formula {Ergₙₑᵤ=[(i−1)·Ergₐₗₜ+SWₙₑᵤ]/i}, where Ergₙₑᵤ represents the new result of the operation, Ergₐₗₜ the previous result of the operation, SWₙₑᵤ the new symbol value and i the number of series of consecutive individual signals received for the signal sequences which have been repeatedly transmitted. According to a further embodiment, the series of symbol values stored in the first register storage device, or the result of a preceding mathematical operation which can be stored in the first register storage device, is overwritten with the result of the current mathematical operation. According to a further embodiment, at least one additional series of symbol values can be determined, for each series of consecutive individual signals, each showing a representation of the series of consecutive individual signals which in each case is displaced by less than one bit width compared to the first and the further series of symbol values. According to a further embodiment, the digital signal sequence which consists of a prescribed number of consecutive individual signals may be repeatedly transmitted some 500 times. According to a further embodiment, the digital signal sequence may be in the form of a spread signal. According to a further embodiment, the digital signal sequence may contain a prescribed header label. According to a further embodiment, the digital signal sequence may be transmitted repeatedly, about 35 times, in the form of a payload signal spread by a spread factor of about 15.

According to another embodiment, a device for the transmission of a digital signal sequence consisting of a prescribed number of individual signals, may comprise:—a first communication device for transmitting and receiving digital signal sequences each of which consists of a prescribed number of individual signals,—a second communication device for transmitting and receiving digital signal sequences each of which consists of a prescribed number of individual signals, wherein at least the first communication device is designed for the repeated transmission of a digital signal sequence consisting of a prescribed number of consecutive individual signals, where the time interval between two consecutively-transmitted digital signal sequences is constant, and where at least the second communication device includes:—a receiving device designed for receiving a first and at least one further series of consecutive individual signals from the repeatedly-transmitted digital signal series, where the number of individual signals in the first and the at least one further series which have been received corresponds to the number of consecutive individual signals prescribed for the digital signal sequence and the further series received are received at a defined time interval after the preceding first or further series which was received,—a symbol value determination device for determining a first series of symbol values representing the first series received and a further series of symbol values representing the at least one further series which has been received, where each symbol value in the first series of symbol values represents exactly one individual signal in the first series which has been received and each symbol value in the at least one further series of symbol values represents exactly one individual signal in the at least one further series which has been received,—a computational device for carrying out a mathematical operation with the first series of symbol values and the at least one further series of symbol values as the arguments, where this mathematical operation is applied in each case to symbol values which correspond to each other in the two series of symbol values and a symbol value from the first series of symbol values corresponds to exactly one symbol value in the at least one further series of symbol values if and only if both symbol values have the same position in their respective series of symbol values, and—a first register storage device for storing the series of symbol values which represents the first series received and for storing the result of the mathematical operation in such a way that each symbol value in the series of symbol values and each individual result of the mathematical operation relating to each individual symbol value is stored in a separate storage area in the first register storage device.

According to a further embodiment, the symbol value determination device can be designed for determining a symbol value representing an individual signal from a series which has been received by comparing a magnitude characteristic of the individual signal with a threshold value in such a way that the symbol value assumes a first value if the characteristic magnitude is greater than the threshold value, and otherwise assumes a second value. According to a further embodiment, the symbol value determination device can be designed for determining a symbol value representing an individual signal from a series which has been received by comparing a magnitude characteristic of the individual signal with a threshold value in such a way that the symbol value assumes a second value if the characteristic magnitude is less than the threshold value, and otherwise assumes a first value.

According to a further embodiment, the symbol value determination device can be designed for determining a symbol value representing an individual signal from a series which has been received by comparing a magnitude characteristic of the individual signal with at least two threshold values, in such a way that the symbol value assumes a value, which is assigned to the threshold value for the two or more threshold values, which has the smallest difference from the characteristic value of the individual signal. According to a further embodiment, the computational device can be designed for carrying out the mathematical operation in the form of an addition. According to a further embodiment, the computational device can be designed for carrying out the mathematical operation in the form of a weighted addition. According to a further embodiment, the computational device can be designed for carrying out the mathematical operation in accordance with the formula {Ergₙₑᵤ=[(i−1)·Ergₐₗₜ+SWₙₑᵤ]/i}, where Ergₙₑᵤ represents the new result of the operation, Ergₐₗₜ the previous result of the operation, SWₙₑᵤ the new symbol value and i the number of series of consecutive individual signals received from the repeatedly-transmitted digital signal sequences. According to a further embodiment, the computational device can be designed to overwrite the series of symbol values stored in the first register storage device, or the result of a preceding mathematical operation which is stored in the first register storage device, with the result of the current mathematical operation. According to a further embodiment, the device may have at least one further register storage device for storing an additional series of symbol values each showing a representation of the series of consecutive individual signals which is displaced by less than one bit width compared to the first and the further series of symbol values. According to a further embodiment, at least the first communication device can be designed to form the digital signal sequence as a spread signal. According to a further embodiment, at least the first communication device can be designed to provide the digital signal sequence with a prescribed header label. According to a further embodiment, at least the first communication device can be designed to transmit repeatedly, up to about 500 times, the digital signal sequence consisting of a prescribed number of consecutive individual signals.

### BRIEF DESCRIPTION OF THE DRAWINGS

Further features of the invention emerge from the following description of exemplary embodiments in accordance with the invention in conjunction with the claims and the figures. In an embodiment, each of the individual features can be realized either on its own or jointly with others. In the explanation below of some exemplary embodiments, reference is made to the attached figures, where

FIG. 1 shows a device for transmitting a digital signal sequence consisting of a prescribed number of individual signals,

FIG. 2 illustrates in a simplified schematic diagram the signal processing at the receiving point, and

FIG. 3 shows the fundamental steps in a method, performed by a device as shown in FIG. 1, for transmitting a digital signal sequence consisting of a prescribed number of individual signals.

### DETAILED DESCRIPTION

According to various embodiments, a method for transmitting a digital signal sequence, consisting of a prescribed number of individual signals, may have steps for the repeated transmission of a digital signal sequence consisting of a prescribed number of consecutive individual signals, for receiving a first series of consecutive individual signals from the digital signal sequence which has been repeatedly transmitted, where the number of individual signals in the first series received corresponds to the number of consecutive individual signals prescribed for the digital signal sequence, for determining a first series of symbol values representing the first series received, where each symbol value in the first series of symbol values represents exactly one individual signal in the first series received, and for storing the series of symbol values which represents the first series received in a first register storage device in such a way that each symbol value from the series of symbol values is stored in a separate storage area in the first register storage device. The method includes in addition steps for the receipt of at least one further series of consecutive individual signals from the repeatedly-transmitted digital signal sequences at a defined time interval after the preceding series of consecutive individual signals which was received, where the number of individual signals in the further series received corresponds in turn to the number of consecutive individual signals prescribed for the digital signal sequence, for determining a further series of symbol values representing the further series which has been received, where each symbol value in the further series of symbol values represents exactly one individual signal in the further series which has been received, for carrying out a mathematical operation with the first series of symbol values and the further series of symbol values as the arguments, where this mathematical operation is applied in each case to symbol values which correspond to each other in the two series of symbol values and a symbol value from the first series of symbol values then corresponds to exactly one symbol value in the further series of symbol values if and only if both have the same position in their respective series of symbol values, and for storing the result of the mathematical operation in the first register storage device.

In this connection, attention is called to the fact that the terms used in this description and in the claims for enumerating features, “include”, “have”, “comprise”, “contain” and “with”, together with their grammatical derivatives, are always to be interpreted as an incomplete enumeration of such features as, for example, method steps, devices, regions, variables and the like, which in no way excludes the presence of other or additional features or groupings of other or additional features.

According to another embodiment, a device for the transmission of a digital signal sequence consisting of a prescribed number of individual signals, may comprise a first communication device for transmitting and receiving a digital signal sequence consisting in each case of a prescribed number of individual signals and a second communication device for transmitting and receiving a digital signal sequence consisting in each case of a prescribed number of individual signals. Here, at least the first communication device is designed for the repeated transmission of a digital signal sequence consisting of a prescribed number of consecutive individual signals, and at least the second communication device includes a receiving device which is designed for receiving a first and at least one further series of consecutive individual signals from the digital signal sequence which has been repeatedly transmitted, where the number of individual signals in the first and the at least one further series which is received corresponds to the number of consecutive individual signals prescribed for the digital signal sequence, and the further series which are received are received at a defined interval of time after the preceding first or further series which was received, a symbol value determination device for determining a first series of symbol values representing the first series which has been received and a further series of symbol values representing the at least one further series which has been received, where each symbol value in the first series of symbol values represents exactly one individual signal in the first series which has been received and each symbol value in the at least one further series of symbol values represents exactly one individual signal in the at least one further series which has been received, a computational device for carrying out a mathematical operation with the first series of symbol values and the at least one further series of symbol values as the arguments, where this mathematical operation is applied in each case to symbol values which correspond to each other in the two series of symbol values and a symbol value from the first series of symbol values then corresponds to exactly one symbol value in the at least one further series of symbol values if and only if both have the same position in their respective series of symbol values, and a first register storage device for storing the series of symbol values which represents the first series received and for storing the result of the mathematical operation in such a way that each symbol value from the series of symbol values and each individual result of the mathematical operation relating to individual symbol values is stored in a separate storage area in the first register storage device.

According to the various embodiments, the low-error transmission of digital signals over transmission channels which are subject to interference is made possible. In particular, it makes possible the transmission of data over distances which are so great that the strength of the received signal is in the region of the background noise, and the transmission of data over transmission links which are subject to substantial interference factors. The computational effort is small by comparison with spread techniques, so that the energy expenditure for transmission is also significantly lower.

The determination of a symbol value which represents an individual signal in a series which has been received is advantageously effected by comparing a magnitude characteristic of the individual signal with a threshold value in such a way that the symbol value assumes a first value if the characteristic magnitude is greater than the threshold value, and otherwise assumes a second value. The determination can also be carried out in such a way that the symbol value assumes a second value if the characteristic magnitude is less than a threshold value, and otherwise assumes a first value.

According to a further embodiment, the determination of a symbol value which represents an individual signal in a series which has been received can be effected by comparing a magnitude characteristic of the individual signal with at least two threshold values, in such a way that the symbol value assumes a value, which is assigned to the threshold value for the two or more threshold values, which has the smallest difference from the characteristic value of the individual signal.

In order to obtain a simple superimposition of the series of symbol values, which conveys the received signal series, the mathematical operation will advantageously include an addition. If necessary the mathematical operation can also include a weighted addition which, for example, permits the formation of an exact mean value or can take into account the grade or quality of each series of individual signals which has been received. In an embodiment, the mathematical operation is performed in accordance with the formula {Ergₙₑᵤ=[(i−1)·Ergₐₗₜ+SWₙₑᵤ]/i}, where Ergₙₑᵤ represents the new result of the operation, Ergₐₗₜ the previous result of the operation, SWₙₑᵤ the new symbol value and i the number of series of consecutive individual signals received for the signal sequences which have been repeatedly transmitted.

It is advantageous if the series of symbol values stored in the first register storage device, or the result of a preceding mathematical operation which is stored in the first register storage device, is overwritten with the result of the current mathematical operation, to enable the size of the register to be kept small.

Since the time-position of the flanks of the individual signals is generally not known, in a preferred embodiment at least one additional series of symbol values is determined, for each series of consecutive individual signals, each showing a representation of the series of consecutive individual signals which in each case is displaced by less than one bit width compared to the first and the further series of symbol values. This additional series of symbol values will be stored in one of the at least one further register storage devices in the device.

For the purpose of improving the quality of the transmission spectrum, the digital signal sequence will preferably be formed from a spread signal.

For the purpose of determining the start of the digital signal sequence in the series of symbol values which is stored in the register, the digital signal sequence can as necessary contain a prescribed header label.

For the purpose of achieving a good transmission quality at a transmission power of about 10 dBm over a transmission link of approximately 500 m and above, the digital signal sequence which consists of a prescribed number of consecutive individual signals can, in a preferred embodiment, be repeatedly transmitted some 500 times.

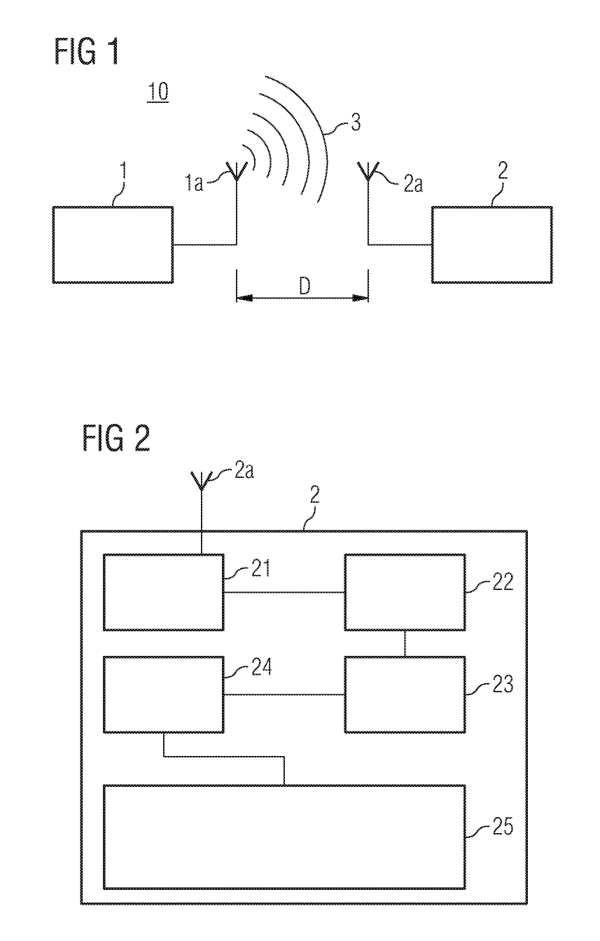

FIG. 1 shows two communication devices 1 and 2 of a device 10 for the transmission 3 of digital signals over large distances. The digital signals are transmitted and received through the antennas 1a and 2a assigned to the respective communication devices 1 and 2 concerned. For the radio trans-mission of the digital signal, the antennas 1a and 2a will preferably be designed for converting the magnetic or the electrical field component of the freespace waves. On the other hand, in the case of optical signal transmission it is expedient if the antennas 1a and 2a are designed for converting light into an electrical quantity and vice versa.

In what follows it is assumed, without any loss of generality, that the digital signals are emitted by the first communication device and are received by the second communication device. The transmission can of course also take place in the opposite direction, in particular for a bidirectional communication between the two communication devices. Furthermore, it is also possible for further communication devices to be involved in the communication.

The maximum transmission power of the transmitting communication device 1 is normally limited to a certain value, generally laid down by law, for example to 10 dBm. For large distances D between the first communication device 1 and the second communication device 2, the strength of the received signal can then assume values in the region of the noise level; in other words, at the receiving communication device the digital signal ‘disappears’ into the noise level.

Digital signals are made up of a series of individual signals, each of which represents a binary character, a so-called bit. In what follows, a digital signal is therefore also referred to as a digital signal sequence. The data communication between the communication devices of device 10 is effected with the help of digital signals which are referred to as telegrams, which contain a prescribed number of binary characters which are transmitted consecutively in time, so that the signals transmitted by the first communication device have a fixed bit length, which is identical for all the telegrams to be transmitted. The communication device 2 is set up for the processing of telegrams or digital signal with this fixed bit length, e.g. 100 bits.

To make it possible to detect the signal which has disappeared into the noise level, the first communication device emits the digital signal several times one after another. The increase in redundancy thereby achieved is utilized at the receiving end to improve the reception sensitivity.

FIG. 2 shows the components of the second communication device which are necessary for receiving a digital signal sequence with a fixed bit length and low signal strength. In the interest of clarity, this diagram omits any representation of the further components necessary for the operation of the communication device or which determine its other functional scope. Nevertheless, it is assumed that these components are present.

After a digital freespace signal 3 has been converted into a wire-borne signal sequence by means of the antenna 2a, the signal sequence is first demodulated in the receiving device 21 of the second communication device 2. The demodulated signal sequence, i.e. strictly speaking the signal sequence with superimposed interference factors, is thereafter fed to the symbol value determination device 22, in which a symbol value is determined for each individual signal in the signal sequence which has been received. Here, the symbol value represents an attribute of the individual signal which is linked to its data content, for example the representation of a logical zero or one. Since the signal strength of an individual signal generally determines its data content, the symbol value will preferably be determined from the amplitude or the energy content of the individual signal. The result of the processing described for the signal sequence by the symbol value determination device 22 is a series of symbol values which show a representation of the binary character sequence of the signal sequence originally transmitted, as influenced by noise and interference signals.

The series of symbol values generated by the symbol value determination device 22 is stored in a first register storage device 24, where each symbol is stored individually in one storage cell. Before it is stored away, the computational device 23 determines how often the digital signal sequence has already been received, converted to a symbol value series and added into the register 24 or superimposed on it. Strictly speaking, it is not the digital signal sequence which is received, but a signal sequence with superimposed interference factors. The fact that the series of individual signals which has been received represents the signal sequence or telegram with superimposed interference is due to the fixed bit length of the telegram. If the signal sequence has been received for the first time, then the register contents will be overwritten with the new series of symbol values. Alternatively, the contents of the register can first be deleted or set to zero, as appropriate, and the series of symbol values then added to it. Instead of an addition, it is also possible to carry out another suitable mathematical operation on the series of symbol values and the register contents which have been set to zero. In the case of overwriting, an addition or a mathematical operation with the purpose of forming a mean value, the register contents after insertion of the first series of symbol values processed by the computational device 23 will be the series of symbol values itself.

Because the digital signal or telegram, as applicable, is emitted repeatedly by the first communication device 1, after the receiving device 21 has received the first telegram this can be followed by yet further ones, for the purpose of improving the accuracy of detection. After demodulation in the receiving device 21 it will, like any subsequent telegrams, be converted into a series of symbol values in the symbol value determination device 22, and this will finally be fed to the computational device 23.

In the simplest case, the computational device 23 adds the newly-obtained series of symbol values to the current contents of the register 24, by symbol value, and stores the result away in the register storage device 24. Assuming that the telegram had been correctly received, each of the storage cells in the register would now contain a value which, in each case, corresponds to double a binary character from the binary character series represented by the digital signal. However, due to the noise and interference components superimposed on the telegram, the actual content of the register deviates to a greater or lesser extent from the binary character series originally communicated in the telegram. Since the noise and the interference signals are not correlated with the signal transmission, the deviations from the original binary character series are now, however, generally less than after the first symbol value series was stored. By the further addition of symbol value series retrieved from telegrams which are transmitted subsequently, over time the content of the register storage device 24 becomes ever more similar to the original binary character series transmitted by the telegram, except for a factor corresponding to the number of telegrams received.

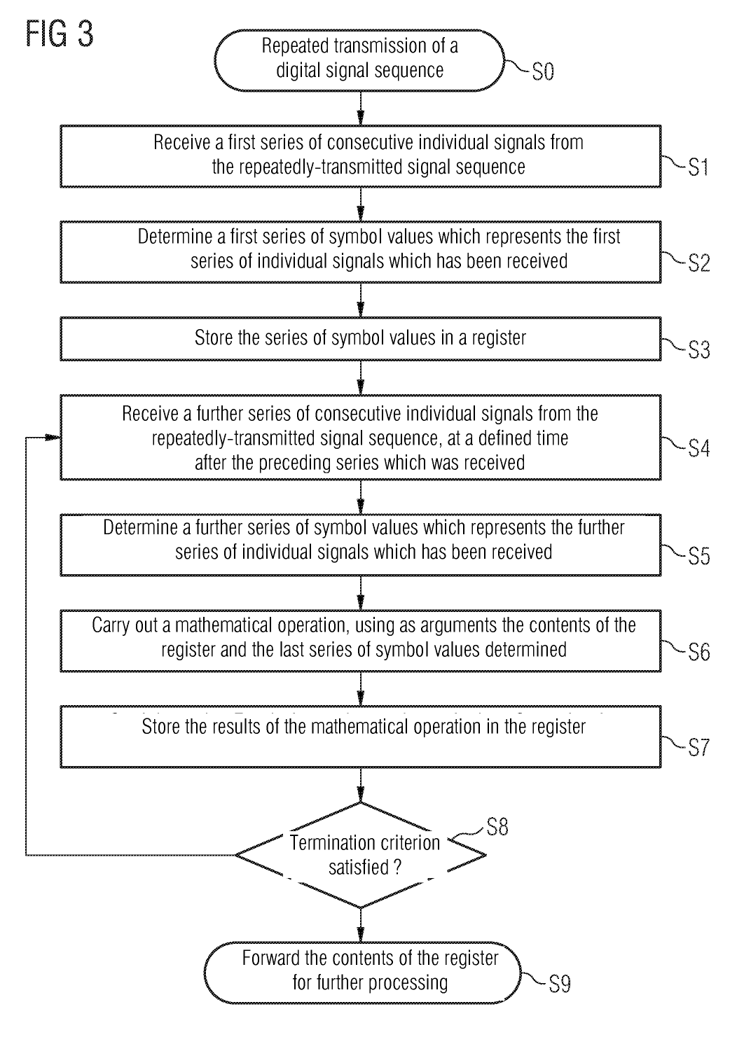

In what follows, the important steps of the method carried out by the device 10 are summarized once more, making reference to FIG. 3. The method starts in step S0 with the repeated transmission by the first communication device 1 of a digital signal sequence consisting of a prescribed number of consecutive individual signals. This digital signal sequence can be formed, for example, by a telegram for data communication between a base station and a mobile station of an electronic vehicle access arrangement.

At the second communication device 2 a first series of consecutive individual signals, from the repeatedly-transmitted digital signal sequence, is received in step S1. The sequence of the individual signals in the signal sequence which is received does not have to agree with the sequence of individual signals in the signal sequence which is repeatedly transmitted, because the receiving device cannot recognize the start of the signal sequence. Normally, therefore, only a residual portion of a first signal sequence will initially be received, to be followed by the missing first portion in another signal sequence which is received. The start of the signal sequence which is transmitted thus generally lies within the signal sequence which has been received.

In step S2 which follows, a first series of symbol values which represents this first received series of individual signals is determined in such a way that each symbol value in this first series of symbol values represents exactly one individual signal from the first series of consecutive individual signals which has been received. In step S3, this first series of symbol values is then stored away in a register 24, where each symbol value from the first series of symbol values is stored in its own separate storage area in the register storage device 24.

In step S4 of the method, a further series of consecutive individual signals from the repeatedly-transmitted signal sequence is received. Logically, this step S4 follows step S3, but in terms of timing it can follow on without interruption after the execution of the method step S1, so that an uninterrupted series of individual signals can be received from an uninterrupted series of digital signal sequences. However, the repeated reception of the individual signal sequences can also take place in intervals which are separated by a time gap, where both the duration of the gap between two receiving intervals and also the duration of the receiving intervals themselves correspond to the transmission time or a multiple of the transmission time for the repeatedly-transmitted digital signal sequence.

As before, for the first series of consecutive individual signals which is received, in step S5 a further series of symbol values is determined for the further series of consecutive individual signals received, where each symbol value represents exactly one individual signal from the further series received. In step S6 which follows, this further series of symbol values is superimposed on the register contents, where the superimposition is performed in the form of a mathematical operation with the register contents and the further series of symbol values as the arguments. Finally, in step S7 the result of the operation is stored away in the register 24.

If the contents of the register satisfy the requirements imposed on them, then in step S8 a decision is made that they will be forwarded to a facility 25 in the device 10 for further processing. If the requirements are not satisfied, the method continues at step S4. A suitable requirement to be checked is the reaching of a predefined number of receipts of the repeatedly-transmitted signal sequence, the receipt of consecutive individual signals of adequate quality, a particular quality of the register contents, and other suchlike.

As the length of the repeatedly-transmitted telegrams, and in particular the number of the binary characters they contain, is constant, the individual telegrams can be transmitted one immediately after another. For the purpose of detecting the binary character sequence contained in the repeatedly-transmitted telegrams, it is not necessary to determine the start of any particular telegram. Rather, the receipt of the telegrams can be started at any arbitrary point in the series of telegram transmissions, so that the register storage position which logically comes first does not necessarily have to contain the first symbol or binary character, as applicable, in the telegram. Rather, the character sequence which is stored can start at any arbitrary position in the telegram's binary character sequence. It is important only that the length of the register storage space used for the storage corresponds exactly to the length of the binary character sequence in the telegrams transmitted, so that one storage position in the register 24 is assigned to each symbol in the bit series and, except for the transition from the last to the first bit in the series, the individual symbol values are arranged (logically) in the sequence corresponding to that of the binary character sequence. If pauses are used between the repeated transmissions of a telegram the register length must also include the ‘pause signals’, which themselves are not data carriers but merely separate the ends of the digital signal sequences from their starts, because it is not possible to distinguish in the individual signals which are received whether or not they are a signal from the signal sequence which has been transmitted.

Instead of using an addition, the computational device 23 can also perform the superimposition of the register contents with a new series of symbol values using other mathematical operations, for example using a weighted addition. This will preferably be effected in the form of the successive formation of arithmetic means, performed according to the equation

Ergₙₑᵤ=[(i−1)·Ergₐₗₜ+SWₙₑᵤ]/i (1)

where Ergₙₑᵤ is the result of the mathematical operation, to be stored away in register storage device, Ergₐₗₜ is the current content of the register storage device 24, SWₙₑᵤ the newly determined symbol values determined by the symbol value determination device and i is the number of signal sequences or telegrams already received, including the current one.

Other weightings are possible, for example so that a series of symbol values in which the underlying individual signals are closer to the values which represent a logical zero or one than in other series is taken into account with a correspondingly higher weighting factor.

The repeated receipt and superimposition of the repeatedly-transmitted digital signal sequences increases the redundancy of the signal relative to uncorrelated influences such as noise and interference signals, so that an improvement in the reception sensitivity is achieved.

As in the case of the superimposition of the symbol value series, derived from the signal sequences which have been received, the determination by the symbol value determination device of the symbol values to represent the individual signals in the signal sequence can also be implemented in various ways. In the simplest embodiment, the determination of the symbol values is effected on the basis of a threshold value, which is referred to for comparison with a magnitude which represents the binary value of the individual signal. If this magnitude is greater than the threshold value, then the symbol value represents a logical zero or one, if it is less than the threshold value, then correspondingly the symbol value represents a logical one or zero. If the magnitude is greater than or equal to the threshold value, then an assignment can be made as a logical zero or alternatively as a logical one.

However, this method has the disadvantage that interference factors have a significant effect on the individual result. In a further preferred embodiment, the magnitude which represents the binary value of the individual signal is therefore preferably compared to several threshold values, where the symbol value used is the threshold value having the smallest deviation from the magnitude of the individual signal referred to. Instead of the assignment of a binary value to each separate individual signal, one obtains in this way a finer gradation, which reflects the degree to which the individual signal represents a binary value. Without loss of generality, assume that the logical zero is represented by an individual signal with magnitude ‘−1’ and the logical one by an individual signal with magnitude ‘+1’. Subdivide the range between ‘−1’ and ‘+1’ into ten equally large intervals, thus obtaining 11 equidistant threshold values, namely −1, −0.8, −0.6, −0.4, −0.2, 0, +0.2, +0.4, +0.6, +0.8, 1. If the magnitude of a current individual signal is 0.38, this gives one with 0.4 a symbol value representing a vague logical one. However, if the magnitude of the current individual signal is −0.88, then with −0.8 one has a symbol value representing a good logical zero. The symbol values obtained reflect the deviations from the ideal magnitudes, and hence also the influence of noise and interference signals or other interference factors, to a finer resolution, so that as a rule a better averaging out of the interference is achieved in the case of repeated transmission. These multiple threshold values can therefore be referred to as ‘soft’ threshold values. A final assessment of series of symbol values stored in the register 24 can then once again be undertaken using a single ‘hard’ threshold value, which in the above example expediently assumes the value ‘0’. In an alternative embodiment, however, it is possible once again at this point to use a ‘soft’ threshold value, so that a probability statement can be made about the contents of the register. After the telegram transmission is completed, or when the series of symbol values stored in the register provides an adequate representation of the binary character sequence in the repeatedly-transmitted telegram, the contents of the register storage device 24 is read out for further processing and forwarded to the subsequent baseband processing 25.

The repeated transmission of the telegrams shows a high autocorrelation, and hence leads to a transmission spectrum which deviates from a random spectrum. For the purpose of realizing a pseudo-random spectrum, required for improved synchronization, the telegram can contain a signal sequence generated using a spread code where, in order to keep the computational effort and energy consumption low, a small spread factor is selected. In practice, spread factors of around 15 combined with a repetition rate of about 35 have proven to be sufficient for low-error transmission of telegrams. The redundancy gain achieved with this combination is about 500. For the spread codes, use can be made of known codes such as for example Barker codes, Manchester codes, Miller codes or the like.

The start of the binary character sequence stored in the register can be found with the help of a predefined header label, which is prepended to the payload data in the telegrams. The payload data can in each case contain a complete message or a part of one. In other words, a message can be subdivided into several blocks which are then transmitted, distributed over several telegrams, using one of the devices described above.

In the examples above, the reconstruction of the binary character sequences contained in the signal sequences which are transmitted has been described in the baseband. Alternatively, the repeatedly-transmitted telegram can also take place before the signal demodulation, at an intermediate frequency level or at the high-frequency level. Rather than in the baseband, the value extraction can also be realized at some other point in the receiver. For example, if the telegram is transmitted using a Frequency Shift Keying method which uses two frequencies (2-FSK), then one of the two frequencies stands for logical zero and the other for logical one. The superimposition of the input signals can then be undertaken using a frequency measurement, where one frequency value is assigned to the zero and the other to one. The conclusion from this example is that, depending on the structure of the receiver concerned and the modulation method used, the value extraction can also be realized at other points in the receiver, that is a different type of signal can be used in extracting the data.

In addition, the system described can also be embedded in more complex structures. For example, by forming the correlation index across the content of the summation register 24 it is possible to recognize whether the register contains a message, i.e. a telegram. Using the correlation index determined, the downstream signal processing, for example, the subsequent baseband processing 25 can be controlled. However, the downstream signal processing can also be operated continuously in order, for example when a telegram of adequate quality is received, immediately to terminate the receipt of repeated transmissions of the telegram, in order to save on computing power and hence to save current.

The device described above is also suitable as a synchronization mechanism for spread spectrum systems. In this case, it is not the telegrams themselves which are superimposed, but the spread symbols, which are treated as continuously transmitted telegrams.

Due to the fact that the strength of the received signal lies at about the noise level, the receiver cannot synchronize on a flank in the signal. In the least favorable case, the flank of the received signal would lie exactly in the middle of an ‘individual signal receipt’. At a transition from a signal value of 0 to a signal value of 1, the content of the register storage area would then be indeterminate for this individual signal. In order to prevent this, the communication device 2 can be provided with at least one further register storage device, in each of which is stored one additional series of symbol values. Each of these additional series of symbol values shows a representation of the series of incoming signals, displaced relative to the series stored in the first register storage device, where each displacement amounts to less than one bit width.

### LIST OF REFERENCE MARKS

1 First communication device
1a Antenna for the first communication device
2 Second communication device
2a Antenna for the second communication device
3 Digital freespace signal
10 Device for signal transmission
21 Receiving device (modulation/demodulation)
22 Symbol value determination device
23 Computational device
24 Register storage device
25 Further processing in the baseband
D Distance from the first to the second communication device
S0-S9 Method steps

What is claimed is:

1. A method for transmitting a digital signal sequence consisting of a prescribed number of individual signals, comprising the following steps:
repeated transmission of a digital signal sequence consisting of a prescribed number of consecutive individual signals, where the time interval between two consecutively-transmitted digital signal sequences is constant,
receiving a first series of consecutive individual signals from the repeatedly-transmitted digital signal sequence, wherein the number of individual signals in the first series which is received corresponds to the number of consecutive individual signals prescribed for the digital signal sequence,
determination of a first series of symbol values representative of the first series received, where each symbol value in this first series of symbol values represents exactly one individual signal from the first series which has been received,
storing the series of symbol values which represents the first series received in a first register storage device in such a way that each symbol value from the series of symbol values is stored in a separate storage area in the first register storage device,
receiving at least one further series of consecutive individual signals from the repeatedly-transmitted digital signal sequences at a defined time interval after the preceding series of consecutive individual signals which was received, where the number of individual signals in the further series which has been received corresponds in turn to the number of consecutive individual signals prescribed for the digital signal sequence,
determining a further series of symbol values, representing the further series which has been received, where each symbol value in the further series of symbol values represents exactly one individual signal in the further series which has been received,
carrying out a mathematical operation with the first series of symbol values and the further series of symbol values as the arguments, where this mathematical operation is applied in each case to symbol values which correspond to each other in the two series of symbol values and a symbol value from the first series of symbol values then corresponds to exactly one symbol value in the further series of symbol values if and only if both have the same position in their respective series of symbol values, and
storing the result of the mathematical operation in the first register storage device.

2. The method according to claim 1, wherein the determination of a symbol value which represents an individual signal in a series which has been received is effected by comparing a magnitude characteristic of the individual signal with a threshold value in such a way that the symbol value assumes a first value if the characteristic magnitude is greater than the threshold, and otherwise assumes a second value.

3. The method according to claim 1, wherein the determination of a symbol value which represents an individual signal in a series which has been received is effected by comparing a magnitude characteristic of the individual signal with a threshold value in such a way that the symbol value assumes a second value if the characteristic magnitude is less than the threshold value, and otherwise assumes a first value.

4. The method according to claim 1, wherein the determination of a symbol value which represents an individual signal in a series which has been received is effected by comparing a magnitude characteristic of the individual signal with at least two threshold values, in such a way that the symbol value assumes a value, which is assigned to the threshold value for the two or more threshold values, which has the smallest difference from the characteristic value of the individual signal.

5. The method according to claim 1, wherein the mathematical operation includes an addition.

6. The method according to claim 1, wherein the mathematical operation includes a weighted addition.

7. The method according to claim 5, wherein the mathematical operation is performed in accordance with the formula {Ergₙₑᵤ=[(i−1)·Ergₐₗₜ+SWₙₑᵤ]/i}, where Ergₙₑᵤ represents the new result of the operation, Ergₐₗₜ the previous result of the operation, SWₙₑᵤ the new symbol value and i the number of series of consecutive individual signals received for the signal sequences which have been repeatedly transmitted.

8. The method according to claim 1, wherein the series of symbol values stored in the first register storage device, or the result of a preceding mathematical operation which is stored in the first register storage device, is overwritten with the result of the current mathematical operation.

9. The method according to claim 1, wherein at least one additional series of symbol values is determined, for each series of consecutive individual signals, each showing a representation of the series of consecutive individual signals which in each case is displaced by less than one bit width compared to the first and the further series of symbol values.

10. The method according to claim 1, wherein the digital signal sequence which consists of a prescribed number of consecutive individual signals is repeatedly transmitted some 500 times.

11. The method according to claim 1, wherein the digital signal sequence is in the form of a spread signal.

12. The method according to claim 1, wherein the digital signal sequence contains a prescribed header label.

13. The method according to claim 1, wherein the digital signal sequence is transmitted repeatedly, about 35 times, in the form of a payload signal spread by a spread factor of about 15.

14. A device for the transmission of a digital signal sequence consisting of a prescribed number of individual signals, comprising:
a first communication device (1, la) for transmitting and receiving digital signal sequences each of which consists of a prescribed number of individual signals,
a second communication device for transmitting and receiving digital signal sequences each of which consists of a prescribed number of individual signals,
wherein
at least the first communication device is designed for the repeated transmission of a digital signal sequence consisting of a prescribed number of consecutive individual signals, wherein the time interval between two consecutively-transmitted digital signal sequences is constant, and wherein at least the second communication device includes
a receiving device designed for receiving a first and at least one further series of consecutive individual signals from the repeatedly-transmitted digital signal series, where the number of individual signals in the first and the at least one further series which have been received corresponds to the number of consecutive individual signals prescribed for the digital signal sequence and the further series received are received at a defined time interval after the preceding first or further series which was received,
a symbol value determination device for determining a first series of symbol values representing the first series received and a further series of symbol values representing the at least one further series which has been received, where each symbol value in the first series of symbol values represents exactly one individual signal in the first series which has been received and each symbol value in the at least one further series of symbol values represents exactly one individual signal in the at least one further series which has been received,
a computational device for carrying out a mathematical operation with the first series of symbol values and the at least one further series of symbol values as the arguments, where this mathematical operation is applied in each case to symbol values which correspond to each other in the two series of symbol values and a symbol value from the first series of symbol values corresponds to exactly one symbol value in the at least one further series of symbol values if and only if both symbol values have the same position in their respective series of symbol values, and
a first register storage device for storing the series of symbol values which represents the first series received and for storing the result of the mathematical operation in such a way that each symbol value in the series of symbol values and each individual result of the mathematical operation relating to each individual symbol value is stored in a separate storage area in the first register storage device.

15. The device according to claim 14, wherein the symbol value determination device is designed for determining a symbol value representing an individual signal from a series which has been received by comparing a magnitude characteristic of the individual signal with a threshold value in such a way that the symbol value assumes a first value if the characteristic magnitude is greater than the threshold value, and otherwise assumes a second value.

16. The device according to claim 1, wherein the symbol value determination device is designed for determining a symbol value representing an individual signal from a series which has been received by comparing a magnitude characteristic of the individual signal with a threshold value in such a way that the symbol value assumes a second value if the characteristic magnitude is less than the threshold value, and otherwise assumes a first value.

17. The device according to claim 14, wherein the symbol value determination device is designed for determining a symbol value representing an individual' signal from a series which has been received by comparing a magnitude characteristic of the individual signal with at least two threshold values, in such a way that the symbol value assumes a value, which is assigned to the threshold value for the two or more threshold values, which has the smallest difference from the characteristic value of the individual signal.

18. The device according to claim 14, wherein the computational device is designed for carrying out the mathematical operation in the form of an addition.

19. The device according to claim 14, wherein the computational device is designed for carrying out the mathematical operation in the form of a weighted addition.

20. The device according to claim 18, wherein the computational device is designed for carrying out the mathematical operation in accordance with the formula {Ergₙₑᵤ=[(i−1)·Ergₐₗₜ+SWₙₑᵤ]/i}, where Ergₙₑᵤ represents the new result of the operation, Ergₐₗₜ the previous result of the operation, SWₙₑᵤ the new symbol value and i the number of series of consecutive individual signals received from the repeatedly-transmitted digital signal sequences.

21. The device according to claim 14, wherein the computational device is designed to overwrite the series of symbol values stored in the first register storage device, or the result of a preceding mathematical operation which is stored in the first register storage device, with the result of the current mathematical operation.

22. The device according to claim 14, wherein the device has at least one further register storage device for storing an additional series of symbol values each showing a representation of the series of consecutive individual signals which is displaced by less than one bit width compared to the first and the further series of symbol values.

23. The device according to claim 14, wherein at least the first communication device is designed to form the digital signal sequence as a spread signal.

24. The device according to claim 14, wherein at least the first communication device is designed to provide the digital signal sequence with a prescribed header label.

25. The device according to claim 14, wherein at least the first communication device is designed to transmit repeatedly, up to about 500 times, the digital signal sequence consisting of a prescribed number of consecutive individual signals.
